(19) United States
(12) Patent Application Publication
(10) Pub. No.: US 2026/0302016 A1
(43) Pub. Date: Oct. 1, 2026

(54) Magnetic Beads

(71) Applicant: SEIKO EPSON CORPORATION, Tokyo (JP)

(72) Inventors: Michio NAKAMORI, Matsumoto (JP); Yasunari IKEDA, Shiojiri (JP); Takeyoshi USHIKI, Shiojiri (JP)

(21) Appl. No.: 19/630,883

(22) Filed: Mar. 27, 2026

(30) Foreign Application Priority Data
Mar. 28, 2025 (JP) 2025-054956

(51) Int. Cl. H01F 1/20; B22F 1/05; B22F 1/16

(52) U.S. Cl. CPC H01F 1/20; B22F 1/05; B22F 1/16; B22F 2302/25; B22F 2302/253; B22F 2302/256; B22F 2302/45; B22F 2304/10

(57) ABSTRACT

A magnetic bead includes a magnetic metal powder and a coating layer coating the surface of the magnetic metal powder, the magnetic metal powder having magnetic properties of 100 to 200 emu/g and a volume-based particle size distribution of 1.0 to 25 μm, the coating layer including a first layer as an outermost layer and a porous second layer formed between the first layer and the magnetic metal powder, and the film thickness of the first layer being smaller than the film thickness of the second layer. The coating layer further includes a third layer between the second layer and the magnetic metal powder.

The present application is based on, and claims priority from JP Application Serial Number 2025-054956, filed Mar. 28, 2025, the disclosure of which is hereby incorporated by reference herein in its entirety.

### BACKGROUND

### 1. Technical Field

The present disclosure relates to magnetic beads.

### 2. Related Art

Magnetic separation process using magnetic beads (magnetic particles) is performed to recover biological substances such as proteins, nucleic acids, and cells from solution.

A coating layer that specifically adsorbs a target substance (target) to be recovered is formed at the surface of the magnetic bead (see JP-A-2022-154413).

JP-A-2022-154413 is an example of the related art.

In order to improve the adsorption efficiency of the target in the magnetic beads, it is effective to reduce the size of the magnetic beads. However, the magnetization of the magnetic beads becomes weaker as the volume thereof becomes smaller, and when the beads are 1 μm or smaller in size, it becomes difficult to attract them with a permanent magnet against the viscous resistance of the liquid. As a result, there is a problem that the recovery process of the target takes time.

In addition, the amount of magnetic beads used may be increased. However, when the amount of magnetic beads used increases, the amount of carry-over liquid (the amount of liquid carried over to the next step) increases, which may lead to a decrease in washing efficiency and a decrease in purity, and thus suppression of the amount of magnetic beads used has been required.

### SUMMARY

An object of the present disclosure is to provide magnetic beads capable of reducing the amount of use while shortening the time of a recovery process.

A magnetic bead according to the present disclosure includes a magnetic metal powder and a coating layer coating the surface of the magnetic metal powder, the magnetic metal powder has magnetic properties of 100 to 200 emu/g and a volume-based particle size distribution D50 of 1.0 to 25 μm, the coating layer includes a first layer as an outermost layer and a porous second layer formed between the first layer and the magnetic metal powder, and the film thickness of the first layer is smaller than the film thickness of the second layer.

### BRIEF DESCRIPTION OF THE DRAWINGS

FIG. 1 is a cross-sectional view showing a magnetic bead of a first embodiment of the present disclosure.

FIG. 2 is a cross-sectional view showing a coating layer of the embodiment.

FIG. 3 is a cross-sectional view showing a coating layer according to a second embodiment of the present disclosure.

### DESCRIPTION OF EMBODIMENTS

### First Embodiment

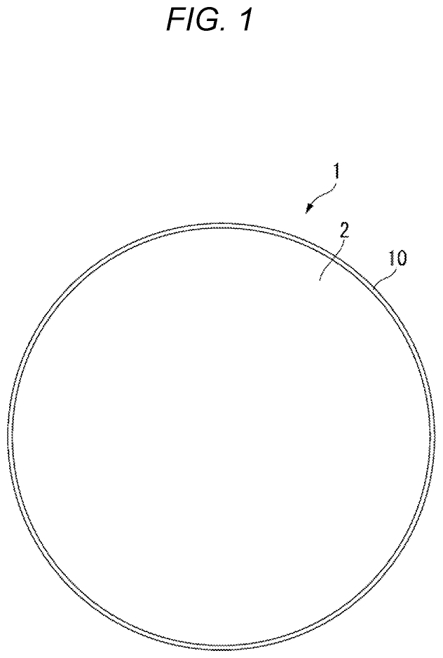

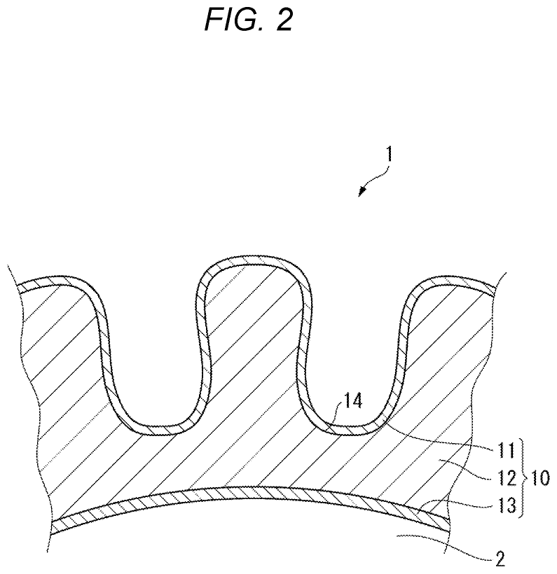

FIGS. 1 and 2 show a first embodiment according to the present disclosure.

In FIG. 1, a magnetic bead 1 of the present embodiment includes a magnetic metal powder 2 and a coating layer 10 coating the surface of the magnetic metal powder 2.

The magnetic metal powder 2 is magnetic metal particles such as an Fe alloy used for magnetic recovery of target substances (target) such as protein, nucleic acid, or cell, and has magnetic properties of 100 to 200 emu/g and a volume-based particle size distribution D50 of 1.0 to 25 μm.

Further, in a state where the coating layer 10 is formed to form the magnetic bead 1, the magnetic metal powder 2 has a specific surface area of 2 to 45 m²/g by nitrogen adsorption and an average pore diameter of 2 to 25 nm by nitrogen adsorption.

In FIG. 2, the coating layer 10 includes a first layer 11 as an outermost layer and a porous second layer 12 formed between the first layer 11 and the magnetic metal powder 2. The coating layer 10 further includes a third layer 13 formed between the second layer 12 and the magnetic metal powder 2.

The first layer 11 is formed of silica, which is the first oxide material, and has a functional group for increasing the bonding property with the target on the surface.

The functional groups of the first layer 11 are selected according to the target substance, and examples thereof include an OH group, a COOH group, an NH₂ group, an epoxy group, a trimethylsilyl group, and an NHS group.

Examples of the target biomolecules include proteins such as streptavidin, protein A, and protein G, as well as antibodies. When the target is a nucleic acid, examples of the preferable substances also include a nucleic acid having a property complementary to the nucleic acid which is the target, specifically, an oligo (dT) primer, CDNA, or the like. When separating cells or exosomes, examples thereof include antibodies such as CD3, CD4, CD8, CD9, CD63, and CD81.

The second layer 12 is formed of any one of alumina, titania, and apatite, which are second oxide materials different from the first oxide material of the first layer 11, and is a porous material having a large number of pores 14. Here, the alkoxide used to form an alumina or titania film on the second layer 12 has higher reactivity to water or a protic solvent than the raw material used to form a silica film on the first layer 11, and therefore pores are more likely to be formed in the structure of the film to be generated during the film-forming process.

The film thickness of the first layer 11 is formed to be sufficiently thinner than that of the second layer 12, and the first layer 11 is formed up to the inner surface of the pore 14, thereby significantly increasing the surface area of the first layer 11 compared with the case where the second layer 12 is not porous.

The third layer 13 is formed of silica which is a material different from the second layer 12 (any one of alumina, titania, and apatite which are second oxide materials), and has a function of suppressing elution of Fe ions from the magnetic metal powder 2 in water in which the target is dispersed.

When the coating layer 10 is formed, the surface of the magnetic metal powder 2 is first coated with the third layer 13, and then the second layer 12 having the pores 14 is formed at the surface of the third layer 13. Further, the surface of the second layer 12 is coated with the first layer 11 so that the inner surfaces of the pores 14 are coated. An existing technique can be used for coating treatment and the like.

### Effects and Advantages of Present Embodiment

The magnetic bead 1 of the present embodiment includes the magnetic metal powder 2 and the coating layer 10 coating the surface of the magnetic metal powder 2, the magnetic metal powder 2 has magnetic properties of 100 to 200 emu/g and a volume-based particle size distribution D50 of 1.0 to 25 μm, the coating layer 10 includes the first layer 11 as the outermost layer and the porous second layer 12 formed between the first layer 11 and the magnetic metal powder 2, and the film thickness of the first layer 11 being smaller than the film thickness of the second layer 12.

In this configuration, the magnetic metal powder 2 has magnetic properties of 100 to 200 emu/g and a volume-based particle size distribution D50 of 1.0 to 25 μm, whereby the magnetic bead 1 can have both a high saturation magnetization property and a high specific surface area. Accordingly, by increasing the saturation magnetization of the magnetic bead 1 and setting the particle diameter of the magnetic bead 1 to the micrometer order, the magnetic particles attached to the target can be quickly recovered, thereby enabling rapid recovery of the target.

In addition, since the coating layer 10 includes the first layer 11 as the outermost layer and the porous second layer 12 formed between the first layer 11 and the magnetic metal powder 2, the total surface area of the first layer 11 including the porous inner surface can be increased, and the target recovery amount can be increased.

In particular, since the film thickness of the first layer 11 is smaller than the film thickness of the second layer 12, the pores 14 of the second layer 12 are not blocked or filled with the material of the first layer 11 when the first layer 11 is formed outside the second layer 12, thereby allowing the first layer 11 to be formed up to the inner surface of the pores 14 of the second layer 12. In other words, the pores 14 of the second layer 12 have a depth that is not filled even when the first layer 11 is formed at the second layer 12. That is, the film thickness of the first layer 11 is less than the depth of the pores 14 of the second layer 12. Accordingly, it is possible to maximize the increase in the total surface area of the first layer 11 using the porous second layer 12.

In the magnetic bead 1 of the present embodiment, the first layer 11 is formed of a first oxide material (silica), and the second layer 12 is formed of a second oxide material (any one of alumina, titania, or apatite) that is different from the first oxide material.

In this configuration, by using an oxide material for each of the first layer 11 and the second layer 12, it is possible to stably manufacture the first layer 11 and the second layer 12 without characteristic deterioration even when they are processed in a high-temperature and high pressure process such as sterilization. In addition, it is possible to form a porous structure in the second layer 12 while ensuring adsorption of the target in the first layer 11.

In the magnetic bead 1 of the present embodiment, the specific surface area by nitrogen adsorption is 2 to 45 m²/g, and the average pore diameter by nitrogen adsorption is 2 to 25 nm.

In this configuration, the amount of the specimen per unit particle of the magnetic bead 1 can be improved.

In the magnetic bead 1 of the present embodiment, the first oxide material of the first layer 11 is silica.

In this configuration, the recovery process can be efficiently performed by using, as the first layer 11, silica having high adsorption to the target.

In the magnetic bead 1 of the present embodiment, the second oxide material of the second layer 12 is any one of alumina, titania, and apatite.

In this configuration, the nucleic acid yield can be increased by facilitating the formation of a porous structure in the second layer 12.

In the magnetic bead 1 of the present embodiment, the coating layer 10 has the third layer 13 between the second layer 12 and the magnetic metal powder 2, and the third layer 13 is formed of a material (silica) different from the second oxide material (any one of alumina, titania, and apatite) of the second layer 12.

In this configuration, elution of Fe ions from the magnetic metal powder 2 in the aqueous solution containing the target can be suppressed by the third layer 13.

In the magnetic bead 1 of the present embodiment, the third layer 13 is silica coated on the surface of the magnetic metal powder 2.

In this configuration, the surface of the magnetic metal powder 2 can be uniformly coated by using silica as the third layer 13.

### Second Embodiment

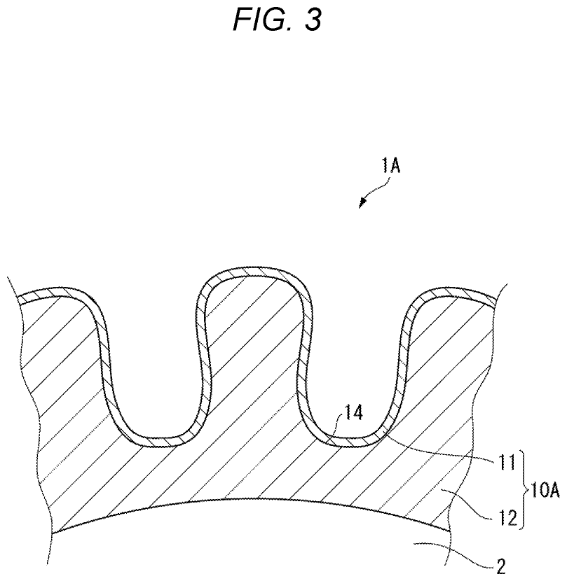

FIG. 3 shows a second embodiment according to the present disclosure.

Similarly to the magnetic bead 1 of the first embodiment described above, a magnetic bead 1A of the present embodiment includes the magnetic metal powder 2 and a coating layer 10A coating the surface of the magnetic metal powder 2. In the present embodiment, the magnetic metal powder 2 is the same as that in the first embodiment described above.

The coating layer 10A of the present embodiment has the first layer 11 and the second layer 12 similar to those of the first embodiment described above. However, the second layer 12 is directly formed at the surface of the magnetic metal powder 2, and the third layer 13 in the first embodiment is omitted.

In such the magnetic bead 1A of the present embodiment, the effect of the third layer 13 in the magnetic bead 1 of the first embodiment (the ability to suppress the elution of Fe ions from the magnetic metal powder 2 into an aqueous solution containing the target) cannot be obtained, but except for this point, the magnetic bead 1A provides the same effects as the magnetic bead 1 of the first embodiment.

Further, in the magnetic bead 1A of the present embodiment, a film-forming step can be omitted since the magnetic bead 1A does not include the third layer 13 provided in the magnetic bead 1 of the first embodiment, and thus the manufacturing process can be simplified as compared with that of the magnetic bead 1.

### Experimental Examples

Specific tests were performed on the magnetic bead 1 of the first embodiment and the magnetic bead 1A of the second embodiment described above.

TABLE 1

| | | | Third Layer | | Second Layer | | |
|---|---|---|---|---|---|---|---|
| | | Particle | | Film | | | Film |
| | Fe Amorphous | Diameter | | thickness | | | thickness |
| | Composition | (μm) | Material | (nm) | Material | | (nm) |
| Example 1 | Fe₇₃Si₁₁Cr₂B₁₁C₃ | 3.5 | Silica | 20 | Alumina | | 100 |
| Example 2 | Fe₇₃Si₁₁Cr₂B₁₁C₃ | 3.5 | — | — | Alumina | | 150 |
| Example 2 | Fe₇₃Si₁₁Cr₂B₁₁C₃ | 1.0 | — | — | Alumina | | 150 |
| Example 3 | Fe₇₃Si₁₁Cr₂B₁₁C₃ | 10 | — | — | Alumina | | 200 |
| Example 4 | Fe₇₃Si₁₁Cr₂B₁₁C₃ | 25 | — | — | Alumina | | 250 |
| Example 5 | Fe₇₃Si₁₁Cr₂B₁₁C₃ | 3.5 | — | — | Alumina | | 30 |
| Example 6 | Fe₇₃Si₁₁Cr₂B₁₁C₃ | 3.5 | — | — | Alumina | | 800 |
| Example 7 | Fe₈₇Cr_{2.6}Si_{9.8} | 3.2 | — | — | Alumina | | 100 |
| Example 8 | Fe₇₃Si₁₀B₁₅C₂ | 4.6 | — | — | Alumina | | 100 |
| Example 9 | Fe₇₃Si₁₁Cr₂B₁₁C₃ | 3.5 | — | — | Titania | | 100 |
| Example 10 | Fe₇₃Si₁₁Cr₂B₁₁C₃ | 3.5 | Silica | 20 | Apatite | | 100 |
| Comparative | Fe₁₀₀ | 3.5 | — | — | Alumina | | 100 |
| Example 1 | (carbonyl iron) | | | | | | |
| Comparative | Fe₇₃Si₁₁Cr₂B₁₁C₃ | 0.4 | — | — | Alumina | | 60 |
| Example 2 | | | | | | | |
| Comparative | Fe₇₃Si₁₁Cr₂B₁₁C₃ | 36 | — | — | Alumina | | 50 |
| Example 3 | | | | | | | |
| Comparative | Fe₇₃Si₁₁Cr₂B₁₁C₃ | 3.5 | — | — | Alumina | | 5 |
| Example 4 | | | | | | | |
| Comparative | Fe₇₃Si₁₁Cr₂B₁₁C₃ | 3.5 | — | — | Alumina | | 1000 |
| Example 5 | | | | | | | |
| Comparative | Fe₇₃Si₁₁Cr₂B₁₁C₃ | 3.5 | — | — | — | | — |
| Example 6 | | | | | | | |
| | First Layer | | Specific | | | Magnetic | Nucleic Acid |
| | | Film | Surface | Pore | Magnetic | Separation | Yield |
| | | thickness | Area | Distribution | Property | Deter- | Deter- |
| | Material | (nm) | m²/g | nm | emu/g | mination | mination |
| Example 1 | Silica | 20 | 5.2 | 9 | 136 | very good | good |
| Example 2 | Silica | 30 | 8 | 10 | 132 | very good | good |
| Example 2 | Silica | 30 | 20 | 10 | 132 | good | very good |
| Example 3 | Silica | 30 | 8.2 | 11 | 127 | very good | good |
| Example 4 | Silica | 30 | 3.5 | 13 | 125 | very good | good |
| Example 5 | Silica | 30 | 2.5 | 3 | 138 | very good | good |
| Example 6 | Silica | 30 | 45 | 25 | 100 | good | good |
| Example 7 | Silica | 30 | 7.6 | 9 | 200 | very good | very good |
| Example 8 | Silica | 30 | 5.3 | 9 | 138 | very good | good |
| Example 9 | Silica | 30 | 3.2 | 20 | 120 | very good | very good |
| Example 10 | Silica | 30 | 7 | 14 | 121 | very good | very good |
| Comparative | Silica | 30 | 4.2 | 10 | 220 | very good | poor |
| Example 1 | | | | | | | |
| Comparative | Silica | 30 | 35 | 9 | 144 | fair | very good |
| Example 2 | | | | | | | |
| Comparative | Silica | 30 | 2 | 13 | 144 | very good | fair |
| Example 3 | | | | | | | |
| Comparative | Silica | 30 | 0.45 | <1 | 144 | very good | poor |
| Example 4 | | | | | | | |
| Comparative | Silica | 30 | 55 | 30 | 144 | poor | fair |
| Example 5 | | | | | | | |
| Comparative | Silica | 30 | 0.45 | <1 | 144 | very good | fair |
| Example 6 | | | | | | | |

In Table 1, Example 1 and Example 10 are magnetic beads having the first layer 11 to the third layer 13 (three-layer structure), Example 2 to 9 and Comparative Example 1 to 5 are magnetic beads 1A without the third layer 13 (two-layer structure), and Comparative Example 6 is magnetic beads in which the coating layer 10 is only the first layer 11.

### Manufacturing of Magnetic Bead 1 of First Embodiment

The magnetic bead 1 is formed by sequentially forming the third layer 13, the second layer 12, and the first layer 11 on the surface of the magnetic metal powder 2.

As the material of the magnetic metal powder 2, Fe amorphous particles (Fe₇₃Si₁₁Cr₂B₁₁C₃) were used in Examples 1 to 6, 9, and 10 and Comparative Examples 2 to 6, while Fe₈₇Cr_{2.6}Si_{9.8} was used in Example 7 and Fe₇₃Si₁₀B₁₅C₂ was used in Example 8. In Comparative Example 1, carbonyl iron (Fe₁₀₀) was used as the magnetic metal powder 2. The particle diameter of the magnetic metal powder 2 was in the range of 1.0 to 25 μm, except for Comparative Examples 2 and 3.

The third layer 13 was formed as follows.

First, the Fe amorphous particles serving as the magnetic metal powder 2 were suspended in an ethanol solvent and stirred for 1 hour under ultrasonic irradiation. Thereafter, NH₃ (actually an aqueous NH₃ solution) serving as a catalyst and pure water were added, followed by slow dropwise addition of TEOS (tetraethoxysilane) over time to perform a silica-coating reaction through hydrolysis and condensation polymerization of TEOS. After the film formation, magnetic separation and solvent substitution (with ethanol) were repeated to recover the particles. The recovered particles were dried on a hot plate at 100° C. for 1 hour, the volatilization of the solvent was confirmed, and then calcination was performed at 200° C. for 2 hours.

The second layer 12 was formed as follows.

The magnetic metal powder 2 on which the third layer 13 was formed was suspended in an ethanol solvent and stirred for 1 hour under ultrasonic irradiation. Thereafter, AIP (aluminum isopropoxide) and pure water were added, and then the mixture was reacted for 4 hours. After the film formation, magnetic separation and solvent substitution (with ethanol) were repeated to recover the particles. The recovered particles were dried on a hot plate at 100° C. for 1 hour, the volatilization of the solvent was confirmed, and then calcination was performed at 200° C. for 2 hours.

The first layer 11 was formed as follows.

The magnetic metal powder 2 on which the second layer 12 and the third layer 13 were formed was suspended in an ethanol solvent and stirred for 1 hour under ultrasonic irradiation. Thereafter, an NH₃ aqueous solution serving as a catalyst and pure water were added, followed by slow dropwise addition of TEOS over time to perform a silica-coating reaction through hydrolysis and condensation polymerization of TEOS. After the film formation, magnetic separation and solvent substitution (with ethanol) were repeated to recover the particles. The recovered particles were dried on a hot plate at 100° C. for 1 hour, the volatilization of the solvent was confirmed, and then calcination was performed at 200° C. for 2 hours. After calcination, the particles were suspended in pure water and heated at 70° C. for 3 hours.

### Manufacturing of Magnetic Beads 1A of Second Embodiment

The magnetic bead 1A is formed by sequentially forming the second layer 12 and the first layer 11 on the surface of the same magnetic metal powder 2 as the magnetic bead 1 of the first embodiment.

Here, the processes for forming the second layer 12 and the first layer 11 are the same as those for the magnetic bead 1 in the first embodiment, and the second layer 12 may be formed directly at the Fe amorphous particles (magnetic metal powder 2), and redundant explanation is omitted.

### Determination of Nucleic Acid Yield

Human genomic DNA was prepared as a nucleic acid model, and lysozyme was prepared as a contaminant model. Next, the magnetic beads of each of Examples 1 to 10 and Comparative Examples 1 to 6 shown in Table 1 were each dispersed in pure water and stirred to prepare magnetic bead suspensions. The content of the magnetic beads in the magnetic bead suspension was 53.17 mass %. Next, reagents other than the nucleic acid were left to stand to reach a room temperature, and then the reagents were charged into a tube in the following order.
Pure water: 65 μL
Nucleic acid dispersion liquid having a concentration of 0.1 μg/μL: 20 μL
Dissolution and adsorption liquid: 750 μL
Lysozyme aqueous solution having a concentration of 10 μg/μL: 15 μL
Magnetic bead suspension: 10 μL

Next, contents of the tube were stirred with a vortex mixer for 10 minutes, then the tube was set at a magnetic stand and allowed to stand for 30 seconds. When the magnetic beads were magnetically trapped, the supernatant was removed.

Next, 900 μL of a washing liquid was added to the tube, followed by stirring with a vortex mixer for 5 seconds and centrifugation. Thereafter, the tube was set at a magnetic stand and allowed to stand for 30 seconds. When the magnetic beads were magnetically trapped, the supernatant was removed. Thereafter, addition of the washing liquid, magnetic trapping, and removal of the supernatant were performed once again.

Next, 900 μL of 70% ethanol aqueous solution was added to the tube, followed by stirring with a vortex mixer for 5 seconds and centrifugation. Thereafter, the contents of the tube were suctioned with a pipette and returned once. Thereafter, the tube was set at a magnetic stand and allowed to stand for 30 seconds. When the magnetic beads were magnetically trapped, the supernatant was removed. Thereafter, addition of the ethanol aqueous solution, magnetic trapping, and removal of the supernatant were performed once again. Next, the tube was subjected to centrifugation, and the remaining supernatant was removed.

Next, 100 μL of pure water was added to the tube, followed by stirring with a vortex mixer for 1 minute to elute the nucleic acid. Thereafter, the tube was set at a magnetic stand and allowed to stand for 30 seconds. When the magnetic beads were magnetically trapped, the elution liquid containing the nucleic acid was recovered into another tube.

Next, the recovered elution liquid was set in a spectrophotometer, and the concentration of the nucleic acid in the elution liquid was determined based on an absorbance at a wavelength of 260 nm. Then, the nucleic acid recovery amount was calculated from the obtained concentration, and the ratio of the nucleic acid recovery amount to the nucleic acid input amount was calculated as the nucleic acid yield.

Since nucleic acid bases have an absorption maximum around 260 nm, the absorbance at a wavelength of 260 nm is used to determine the concentration of nucleic acids.

The nucleic acid yield calculated as described above was determined as follows.
Very good: nucleic acid yield is 80% or more
Good: nucleic acid yield is 60% or more and less than 80%
Fair: nucleic acid yield is 40% or more and less than 60%
Poor: nucleic acid yield is less than 40%

### Determination of Magnetic Separation Time

The magnetic separation time was performed by measuring a change in absorbance when a magnet was brought close. Into the cuvette, 2.5 mL of PBS and 5 μL of the magnetic bead suspension are placed. After capping and inverting the cuvette for stirring,
it is set in a spectrophotometer (Hitachi High-Technologies U-3900H),
the wavelength is adjusted to 550 nm,
and absorbance measurement is started. The time from when the permanent magnet was brought into close contact with the side of the cuvette until the absorbance decreased to 10% of the initial value (i.e., a 90% reduction) was measured as the magnetic separation time.

The magnetic separation time measured as described above was determined as follows.
Very good: magnetic separation time is 10 seconds or less
Good: magnetic separation time exceeds 10 seconds and is 60 seconds or less
Fair: magnetic separation time exceeds 60 seconds and is 300 seconds or less
Poor: magnetic separation time exceeds 300 seconds

### Evaluation Results

In Examples 1 to 10 according to the present disclosure, favorable results were obtained in which both the nucleic acid yield and the magnetic separation time were rated as “Very good” or “Good”.

In contrast, in Comparative Examples 1 to 6, which were not in accordance with the present disclosure, only insufficient results of “Fair” or “Poor” in either the nucleic acid yield or the magnetic separation time were obtained.

Comparative Example 1: The magnetic metal powder 2 is Fe₁₀₀, and although its saturation magnetization in the magnetic properties is as high as 220 emu/g and the magnetic separation is fast, a sufficient value is not obtained for the nucleic acid yield. This is considered to be since the magnetic metal powder 2, which does not contain Cr, undergoes corrosion that causes Fe ions to elute, and the eluted Fe ions strongly bind to the nucleic acid, preventing it from being eluted from the magnetic beads and thereby reducing the nucleic acid yield.

In contrast, in Examples 1 to 10, the magnetic properties of the magnetic metal powder 2 are within the range of 100 to 200 emu/g (see Examples 6 and 7), and a sufficient nucleic acid yield is obtained.

Comparative Example 2: The magnetic properties are within the range of 100 to 200 emu/g, but since the particle diameter is as small as 0.4 μm, the magnetization per particle is small and the magnetic separation time is long.

In contrast, in Examples 1 to 10, the particle diameter of the magnetic metal powder 2 is within the range of 1.0 to 25 μm (see Examples 2 and 4), and the magnetic separation time is shortened.

Comparative Example 3: The magnetic properties are within the range of 100 to 200 emu/g, but the particle diameter is as large as 36 μm and the specific surface area is small, resulting in a reduced nucleic acid yield.

In contrast, in Examples 1 to 10, the particle diameter of the magnetic metal powder 2 is in the range of 1.0 to 25 μm, and the specific surface area is in the range of 2 to 45 m²/g (see Examples 5 and 6), and a sufficient nucleic acid yield is obtained.

Comparative Example 4: The film thickness of the alumina forming the porous second layer 12 is as thin as 5 nm, resulting in a pore size distribution as small as 1 nm and a limited specific surface area of only 0.45 m²/g, leading to a reduced nucleic acid yield.

In contrast, in Examples 1 to 10, the film thickness of the second layer 12 is in the range of 30 to 800 μm, and thus the specific surface area is in the range of 2 to 45 m²/g (see Examples 5 and 6), and a sufficient nucleic acid yield is obtained.

Comparative Example 5: The film thickness of the alumina that forms the porous second layer 12 is as large as 1000 nm, resulting in poor magnetic separation. Furthermore, since the film thickness of the second layer 12 is large, the pores 14 become large, the adsorbed nucleic acid cannot be desorbed, resulting in a reduced nucleic acid yield.

In contrast, in Examples 1 to 10, the film thickness of the second layer 12 is in the range of 30 to 800 μm, and thus the specific surface area is in the range of 2 to 45 m²/g (see Examples 5 and 6), and a sufficient nucleic acid yield is obtained.

Comparative Example 6: Since the porous second layer 12 is not present and the specific surface area is as small as 0.45 m²/g, the nucleic acid yield is low.

In contrast, in Examples 1 to 10, the specific surface area can be set within the range of 2 to 45 m²/g by the porous second layer 12, and a sufficient nucleic acid yield is obtained.

### Summary of Present Disclosure

A magnetic bead according to a first aspect of the present disclosure includes the magnetic metal powder and the coating layer coating the surface of the magnetic metal powder, the magnetic metal powder has magnetic properties of 100 to 200 emu/g and a volume-based particle size distribution D50 of 1.0 to 25 μm, the coating layer includes the first layer as the outermost layer and the porous second layer formed between the first layer and the magnetic metal powder, and the film thickness of the first layer is smaller than the film thickness of the second layer.

In this configuration, the magnetic metal powder has magnetic properties of 100 to 200 emu/g and a volume-based particle size distribution D50 of 1.0 to 25 μm, whereby the magnetic bead can have both a high saturation magnetization property and a high specific surface area, enabling target recovery in a short time.

In addition, since the coating layer includes the first layer as the outermost layer and the porous second layer formed between the first layer and the magnetic metal powder, the total surface area of the first layer including the porous inner surface can be increased, and the target recovery amount can be increased.

In particular, since the film thickness of the first layer is smaller than the film thickness of the second layer, the pores of the second layer are not blocked or filled with the material of the first layer when the first layer is formed outside the second layer, thereby allowing the first layer to be formed up to the inner surface of the pores of the second layer. Accordingly, it is possible to maximize the increase in the total surface area of the first layer using the porous second layer.

In the magnetic bead of the present disclosure, the first layer is formed of the first oxide material, and the second layer is formed of the second oxide material different from the first oxide material.

In this configuration, by using an oxide material for each of the first layer and the second layer, it is possible to stably manufacture the first layer and the second layer without characteristic deterioration even when they are processed in a high-temperature and high-pressure process such as sterilization. In addition, it is possible to form a porous structure in the second layer while ensuring the adsorption property of the target in the first layer.

In the magnetic bead of the present disclosure, the specific surface area by nitrogen adsorption is 2 to 45 m²/g, and the average pore diameter by nitrogen adsorption is preferably 2 to 25 nm.

In this configuration, the amount of the specimen per unit particle can be improved.

In the magnetic bead of the present disclosure, the first oxide material is preferably silica.

In this configuration, the recovery process can be efficiently performed by using silica having high adsorption to the target.

In the magnetic bead of the present disclosure, the second oxide material is preferably any one of alumina, titania, and apatite.

In this configuration, the nucleic acid yield can be increased by facilitating the formation of a porous structure.

In the magnetic bead of the present disclosure, it is preferable that the coating layer includes the third layer between the second layer and the magnetic metal powder, and the third layer is formed of a material different from that of the second layer.

In this configuration, elution of Fe ions from the magnetic metal powder in the aqueous solution containing the target can be suppressed.

In the magnetic bead of the present disclosure, the third layer is preferably silica coated on the surface of the magnetic metal powder.

In this configuration, by using silica as the third layer, the surface of the magnetic metal powder can be uniformly coated.

What is claimed is:

1. A magnetic bead comprising: a magnetic metal powder and a coating layer coating the surface of the magnetic metal powder,
wherein the magnetic metal powder has magnetic properties of 100 to 200 emu/g and a volume-based particle size distribution D50 of 1.0 to 25 μm,
the coating layer includes a first layer as an outermost layer and a porous second layer formed between the first layer and the magnetic metal powder, and
the film thickness of the first layer is smaller than the film thickness of the second layer.

2. The magnetic bead according to claim 1, wherein the first layer is formed of a first oxide material, and the second layer is formed of a second oxide material different from the first oxide material.

3. The magnetic bead according to claim 2, wherein a specific surface area by nitrogen adsorption is 2 to 45 m²/g, and an average pore diameter by nitrogen adsorption is 2 to 25 nm.

4. The magnetic bead according to claim 3, wherein the first oxide material is silica.

5. The magnetic bead according to claim 4, wherein the second oxide material is any one of alumina, titania, and apatite.

6. The magnetic bead according to claim 1, wherein the coating layer includes a third layer between the second layer and the magnetic metal powder, and the third layer is formed of a material different from that of the second layer.

7. The magnetic bead according to claim 6, wherein the third layer is silica coated on the surface of the magnetic metal powder.
